(19) United States
(12) Patent Application Publication
(10) Pub. No.: US 2025/0334150 A1
(43) Pub. Date: Oct. 30, 2025

(54) POLYURETHANE BUSHING WITH CAST-IN-PLACE POLYMER LINER

(71) Applicant: Bunker Corp. DBA Energy Suspension, San Clemente, CA (US)

(72) Inventor: Selma Pauline Babic, San Clemente, CA (US)

(73) Assignee: Bunker Corp. DBA Energy Suspension, San Clemente, CA (US)

(21) Appl. No.: 19/193,239

(22) Filed: Apr. 29, 2025

Related U.S. Application Data
(60) Provisional application No. 63/640,473, filed on Apr. 30, 2024.

(51) Int. Cl. F16C 33/20

(52) U.S. Cl. CPC F16C 33/20

(57) ABSTRACT

A sway bar bushing includes an outer body having an outer surface and an inner surface, with the outer surface being adapted to interface with a sway-bar mounting bracket. The sway bar bushing additionally includes an inner liner formed of polytetrafluoroethylene. The inner liner includes an inner surface disposable in contact with an outer surface of a sway bar, an outer surface, and a helical rib protruding radially outwardly from the outer surface of the inner liner and into the outer body from the inner surface thereof. The interface between the helical rib and the outer body strengthening engagement between the outer body and the inner body.

### CROSS-REFERENCE TO RELATED APPLICATIONS

The present application claims the benefit of U.S. Provisional Application No. 63/640,473, filed Apr. 30, 2024, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a bushing for a vehicle, and more specifically to a sway bar bushing or control bar bushing having a cast-in-place lubricating liner.

### 2. Description of the Related Art

Sway bars are commonly used in a vehicle suspension system to help the vehicle handle turns and prevent body lean of the vehicle. A typical sway bar may be attached to the vehicle chassis via a sway bar bushing, which typically extends around the sway bar and interfaces with an external mounting bracket.

It is common to use a lubricant in a sway bar bushing to mitigate wear between the bushing and the sway bar. To that end, conventional sway bar bushings are typically cast with smooth bores or also with bores that accommodate a separate lubricant in “grease grooves.” Some versions may allow for periodic re-lubrication with features for re-greasing, as the lubrication may dissipate over time.

The re-greasing of conventional sway-bar bushings may be troublesome for users. Along these lines conventional sway bar bushings include open ends and an axial slit, which may allow the lubricant added at assembly to easily leak out over time. Also, polyurethane sway bar bushings of all types can and do make a squeaking noise when entering or using the vehicle. This noise is very annoying for users and is the source of many complaints about sway bar bushings, in some cases causing users to select other types.

A conventional lubricant also wears off in a relatively short time. When this happens the bushings may become noisy, rough acting, and also can generate substantial heat in the bushings, shortening their life by degrading the polymer if the temperature exceeds certain limits.

Renewing of the conventional lubricant may involve completely disassembling the sway bar assembly on the vehicle and adding conventional lubricant before re-assembling. Disassembly of the sway bar assembly on a regular basis to renew lubricant may be difficult and time consuming for consumers. Alternately, re-greasable designs may allow for re-greasing at periodic intervals using a grease gun. The requirement of renewing lubricant on a regular basis, whether by disassembly of the sway bar assembly or by grease gun, may become very expensive for consumers.

The fact that the conventional lubricant wears off in a short period also allows the bushing to suffer additional heating and also accelerated wear due to the lack of lubricant. This will shorten the service life of the conventional bushings and create a need to replace them to maintain vehicle performance.

Accordingly, there is a need in the art for a sway bar bushing that offers more optimal friction reduction/lubrication capabilities. Various aspects of the present disclosure address this particular need, as will be discussed in more detail below.

### BRIEF SUMMARY

Various aspects of the present disclosure are directed toward a sway bar bushing including a cast polyurethane outer shell which varies to fit the particular features of a vehicle, with a fabric inner liner of polytetrafluoroethylene (PTFE) material, which also varies to fit different sway bar diameters. The liner is cast-in-place, securing it firmly by adhering to the fabric texture and seam that are part of the liner construction.

According to one embodiment, there is provided a sway bar bushing including an outer body having an outer surface and an inner surface, with the outer surface being adapted to interface with a sway-bar mounting bracket. The sway bar bushing additionally includes an inner liner formed of polytetrafluoroethylene. The inner liner includes an inner surface disposable in contact with an outer surface of a sway bar, an outer surface, and a helical rib protruding radially outwardly from the outer surface of the inner liner and into the outer body from the inner surface thereof. The interface between the helical rib and the outer body strengthening engagement between the outer body and the inner body.

According to another embodiment, there is provided a method of forming a sway bar bushing. The method includes the step of forming an inner liner of polytetrafluoroethylene. The inner liner includes an inner surface disposable in contact with an outer surface of a sway bar, an outer surface, and a helical rib protruding radially outwardly from the outer surface of the inner liner. The method additionally includes the step of forming an outer body around the inner liner, with the outer body having an outer surface and an inner surface, with the outer surface being adapted to interface with a sway-bar mounting bracket. The outer body is formed on the inner liner such that the helical rib extends into the inner surface of the outer body, with the interface between the helical rib and the outer body strengthening engagement between the outer body and the inner body.

The step of forming the outer body may include molding the outer body to the inner liner.

The step of forming the inner liner may include the use of a core, about which the inner liner is formed. The step of forming the inner liner may occur prior to the step of forming the outer body.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an exploded upper perspective view of a sway bar bushing including an inner polymer liner and an outer bushing body;

FIG. 2A is an upper perspective view of the sway bar bushing;

FIG. 2B is a top view of the sway bar bushing of FIG. 2A;

FIG. 2C is an end view of the sway bar bushing of FIG. 2A;

FIG. 2D is a rear view of the sway bar bushing of FIG. 2A;

FIG. 3 is an end perspective view of the sway bar bushing;

FIG. 4 is an upper perspective view of the sway bar bushing, wherein the sway bar bushing is resting on one end;

FIG. 5 is a perspective view of the inner liner included in the sway bar bushing resting on one end;

FIG. 6 is an upper perspective view of the inner liner;

FIG. 7 is an end view of the inner liner; and

FIG. 8 is a front view of the inner liner.

Common reference numerals are used throughout the drawings and the detailed description to indicate the same elements.

### DETAILED DESCRIPTION

The detailed description set forth below in connection with the appended drawings is intended as a description of certain embodiments of a sway bar bushing and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

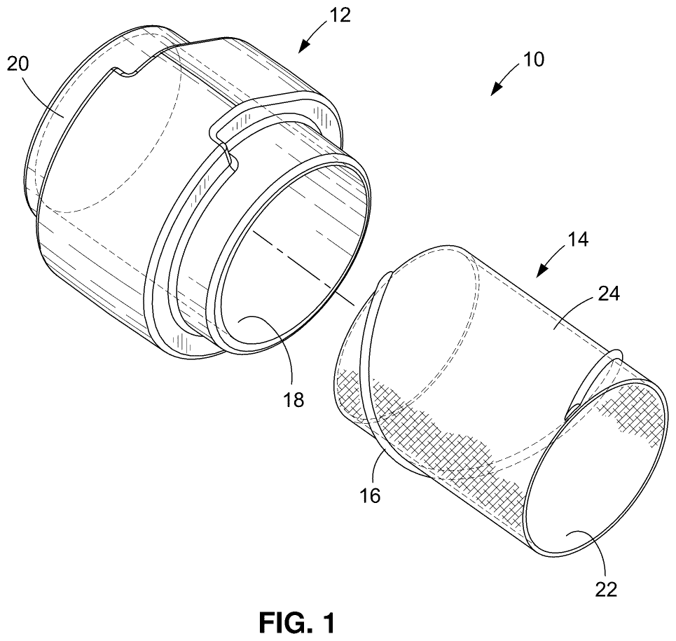

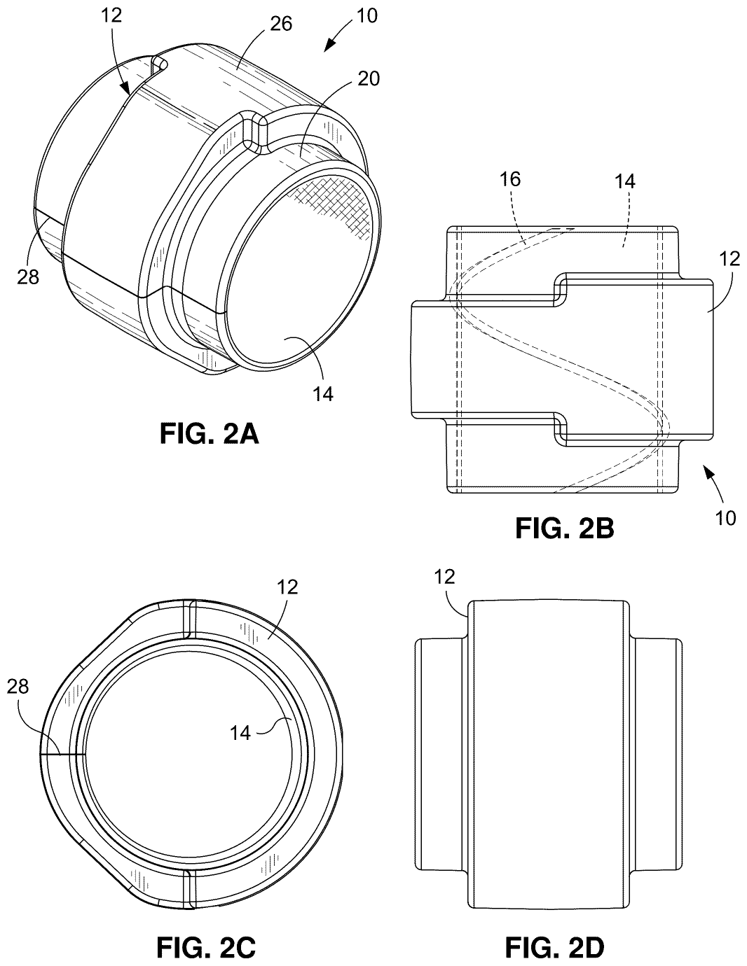

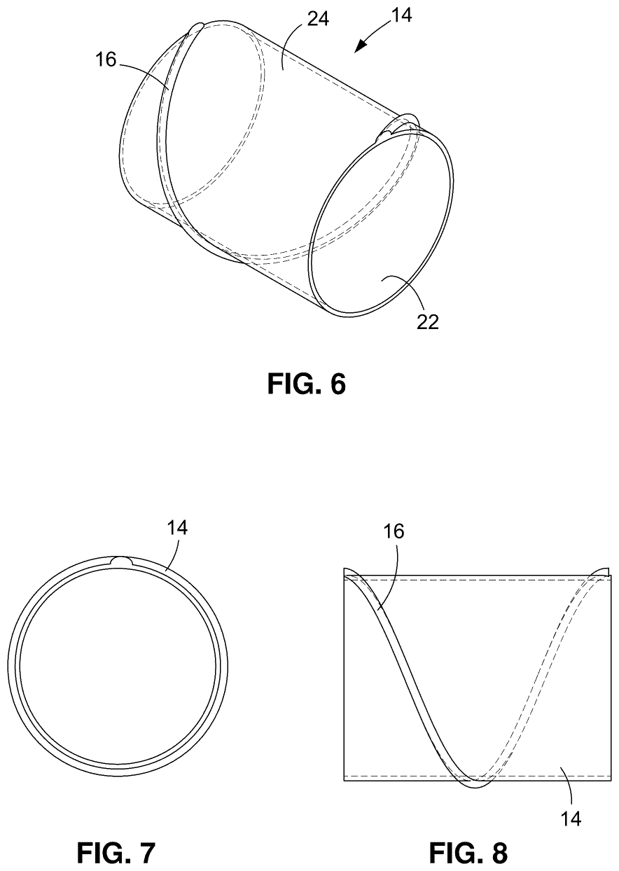

Referring now to the drawings, wherein the showings are for purposes of illustrating preferred aspects of the present disclosure, and are not for purposes of limiting the same, FIG. 1 shows a Polytetrafluoroethylene (PTFE or TEFLON) lined sway bar bushing 10. The bushing 10 may be comprised of two pieces, namely, an outer sway bar shell/body 12, which may be formed of cast polyurethane, and an internal fabric sleeve/liner 14, which may be made from PTFE fibers. The outer casting of the polyurethane outer shell 12 may be of varying durometers based on performance requirements. The cast outer body 12 has an inner wall 18 designed to retain the fabric liner 14 and an outer wall 20 designed to interface with a sway-bar mounting bracket. Alternate views of the outer body 12 may be found in FIGS. 2A-D. The inner PTFE fabric liner 14 may be a special construction TEFLON fiber fabric formed into a tube, forming an inner surface 22 designed to be disposed around the outer surface of a sway bar and act as a lubricant. The PTFE fabric liner further forms an outer surface 24 designed to be adhered to and partially retained within the inner wall 18 of the outer body 12. The fabric liner 14 includes a seam/rib 16 protruding radially outward from the outer surface 24 of the liner 14. This seam 16 may be used as part of the adhering or locking mechanism that maintains a desired relationship between the inner wall 18 of the outer shell 12 and the outer surface 24 of the inner liner 14. Alternate views of the inner liner 14 and helical rib 16 may be found in FIGS. 5-8. The outer shell 12 and inner liner 14 may be adhered or connected together tightly as a result of casting the outer shell 12 over the PTFE liner 14 and providing for them an arrangement to maintain their relationship with the seam 16 and fabric texture. The bushing 10 with outer body 12 and fabric liner 14 adhered may be seen in FIGS. 2A, 3, and 4.

According to one embodiment, the outer wall 20 of the body 12 has an elevated midsection 26 extending outwardly from the surface of the outer wall 20 of the body 12, which may be seen first in FIG. 1 and in FIG. 2A. The elevated midsection 26 is configured so that the bushing 10 interfaces optimally with a sway-bar mounting bracket of a specific vehicle type. It is contemplated by this disclosure that the elevated midsection 26 may not be present in every embodiment of the bushing 10, depending on the mounting bracket and vehicle type the bushing 10 is created for. Among other possible variations, the bushing 10 may alternatively have no elevated midsection 26, and/or may have a section of the outer wall 20 flattened, the rest of the outer wall 20 being rounded to optimally interface with the mounting bracket.

According to one embodiment, the sway bar bushing 10 is formed by initially forming the inner liner 14, which may entail the use of a mold core or core pin. In this regard, the fibers of the inner liner 14 may be wound around the mold core or core pin to achieve a desired shape, diameter, weave, and porosity. The edges of the inner liner 14 are then ultrasonically welded around the core pin, creating the helical seam 16. Though the present embodiment discloses forming the inner liner 14 around a core pin to achieve the desired configuration and ultrasonically welding the edges to form the helical seam 16, it has been contemplated by this disclosure that the inner liner 14 and protruding helical seam 16 may be formed in any number of other ways known in the art. It is also contemplated by this disclosure that the length of the liner 14 may be equal to the length of the outer body 12 or greater than the length of the outer body 12, causing the inner liner 14 to protrude outwardly from each end of the outer body 12.

The helical seam 16 protrudes from the outer surface 24 of the inner liner 14 and may be formed in a variety of configurations. In this regard, the periodic frequency of the helix may vary along the length of the inner liner 14 without departing from the sprit and scope of the present disclosure. For instance, in some embodiments, the helical seam 16 may not complete a complete circumnavigation of the outer surface along the length of the inner liner 14, while in other embodiments, the helical seam 16 may circumnavigate the outer surface multiple times. A tighter helix (e.g., more circumnavigations) may strengthen engagement between the outer body 12 and the inner liner 14.

According to one embodiment, the outer body 12 is formed by casting polyurethane around the inner liner 14. To achieve said casting of the outer body, the inner liner 14 disposed upon the core pin is placed between each piece of a two-piece mold. The outer body 12 may then be atmospherically cast into the two-piece mold around the inner liner 14. Casting the outer body 12 around the inner liner in such a manner allows for the polyurethane to adhere to and be partially incorporated within the liner 14, such that the polyurethane penetrates the porosity of the outer surface 24 of the liner 14. The porosity of the liner 14 allows for stronger adherence to and incorporation of the outer body 12 with the liner 14. The viscous polyurethane is allowed to adhere to and incorporate itself within the PTFE, creating a greater surface area of interaction between the polyurethane and PTFE when compared to smooth surfaces. Additionally, the outer body 12 is cast around the inner liner 14 such that the helical seam 16 extends into and is incorporated within the inner surface 18 of the outer body 12, yet further increasing the surface area with which the polyurethane may interact, thus further increasing the adherence between the outer body 12 and inner liner 14.

The advantage of increasing the interaction between the outer body 12 and the inner liner 14 is that the mechanical retention between the outer body 12 and the inner liner 14 is greater than the force applied in use, which decreases the possibility of the outer body 12 separating from the liner 14 in use. Additionally, the axial retention of the bushing 10 is improved due to the helical seam, preventing the bushing 10 from any movement that may affect functionality of the bushing 10. The bushing and liner are then allowed to cure, the core pin is taken out and the mold removed. While curing, the polyurethane retains the shape of the mold and becomes embedded in the fabric of the liner 14, but the tight fit between the core pin and the sleeve prevents the polyurethane from seeping all the way through the liner 14 to the inner surface 22 of the liner 14. This allows for the improved adherence of the outer body 12 to the liner 14 without compromising the functionality of the liner as a substitute for lubricant.

Once cured, an axial slit 28 is created in the bushing 10 allowing for the cylindrical form of the bushing 10 to be opened. The axial slit 28 may be seen first in FIG. 2A. The axial slit 28 is cut through both the outer body 12 and the inner liner 14 extends the length of the bushing 10 from one end to another, allowing the cylinder to be separated from itself at a specific point. The slit 28 is configured to allow for easy installation of the bushing 10. The slit 28 allows for the bushing 10 to be separated and slipped onto the sway bar of a vehicle, without having to slide the bushing 10 from the end of the sway bar to the desired positioning. Though the present embodiment discloses an axial slit 28, it is contemplated that another embodiment of the bushing 10 may include a different type of slit or may not include a slit.

The views depicted in FIGS. 2A-2D illustrates the sway bar bushing 10 and details of the coaxial arrangement of the outer body 12 and fabric liner 14. More specifically, FIGS. 2A-2D depict one embodiment of the sway bar bushing 10 wherein the ends of the fabric liner 14 are flush with the ends of the outer body 12, the length of the fabric liner 14 being the same as the length of the outer body 12. FIG. 2A depicts the assembled sway bar bushing 10 with the outer body 12 cast around and affixed to the liner 14. FIG. 2B depicts a top view of the assembled sway bar busing 10 wherein the fabric liner 14 and helical seam 16 are shown in phantom. FIG. 2C depicts an end view of the assembled sway bar bushing 10, the fabric liner 14 being affixed to the outer body 12. FIG. 2D depicts a rear view of the sway bar bushing 10.

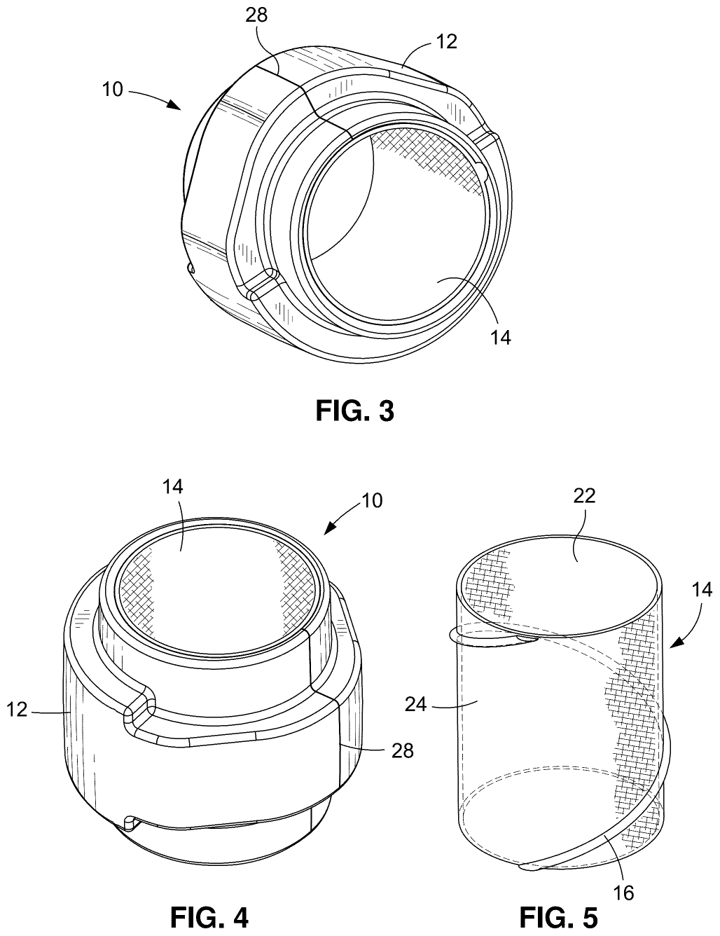

The bushing 10 depicted in FIGS. 3-4 show various perspective views of the assembled bushing 10, while FIGS. 5-8 depict various views of the inner liner 14.

The TEFLON-lined sway bar bushing 10 demonstrates the several advantages for the user. The integration of the liner 14 as a lubricant, cast-in-place into the outer body 12 during manufacturing, is an innovation advancing the product design. Conventional designs treat the lubricant as a separate component to be added at assembly. Using conventional lubricants added at the initial assembly tends to be a messy and cumbersome during installation and a costly factor in the maintenance of the bushings. The TEFLON-lined bushing 10 acts as the lubricant and may not require any additional lubricant for its life. When assembling a conventionally added lubricant, the lubricant may get on or within areas or parts that lubricant may not be wanted. As such, the lubricant application process may be messy and may require cleaning after application. Additionally, lubricant may sometimes get into areas that cause other functions of the vehicle to be compromised.

A conventional lubricant also wears off in a relatively short time. When this happens the bushings may become noisy, rough acting and also can generate substantial heat in the bushings shortening their life by degrading the polymer of the temperature exceeds certain limits.

Renewing of the conventional lubricant may involve completely disassembling the sway bar assembly on the vehicle and adding conventional lubricant before re-assembling. Alternately, re-greasable designs may allow for re-greasing at periodic intervals using a grease gun. This is annoying and possibly expensive for the vehicle owner.

The fact that the conventional lubricant wears off in a short period also allows the bushing to suffer additional heating and also accelerated wear due to the lack of lubricant. This will shorten the service life of the conventional bushings and create a need to replace them to maintain vehicle performance.

When installing the conventional bushings, the lubricant may get on to surfaces of the bushing that you do not want to be lubricated (such as the outer diameter) because relative motion between the bushing clamp and the bushing outer diameter is undesirable, as such motion may affect the retention of the bushing. The disclosed bushing 10 decreases motion between the outer diameter and mounting clamp, and thus, increases retention when compared to conventionally designed bushings.

The material characteristic of polyurethane is to return to its originally molded shape, and it has a quality of “stiction” that when sticking to a mating surface will slip and re-stick causing vibration and noise at the interface of the bushing and mating part where there is relative motion.

The TEFLON-lined bushing 10 may operate smoothly without stiction because the cast-in-place TEFLON lubricating layer may eliminate the stiction that occurs with conventional polyurethane bushings due to the adherence of the liner 14 to the outer body 12. This means that this new type of bushing 10 may be very quiet in operation, very smooth in operation, and generate less heat that previous designs.

With the smooth bushing-to-bar operation comes an improvement in the overall operation of the vehicle sway bar system, which is smoothly transferring spring force from side to side of a vehicle equipped with such a device. Sticking, vibration, and noise are minimized.

While the foregoing describes the inner liner 14 as including a single helical seam 16, it is contemplated that multiple helical seams (e.g., a double-helix, or three-plus helixes) may be incorporated in the inner liner 14 without departing from the spirit and scope of the present disclosure. It is also contemplated that in some embodiments, the seam 16 may be non-helical in nature. In this regard, the seam 16 may be circular, with one or more circular seams protruding from the outer surface of the liner 14.

Although the foregoing describes the outer body 12 as being formed from polyurethane and the inner body 14 as being formed from PTFE, other materials known in the art may also be used without departing from the spirit and scope of the present disclosure. Furthermore, any dimensions provided herein or the associated drawings are merely for exemplary purposes only. In this regard, it is understood that the dimensions may vary from one embodiment to the next.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A sway bar bushing comprising:
an outer body having an outer wall surface and an inner wall surface, the outer wall surface being adapted to interface with a sway-bar mounting bracket; and
an inner liner formed of polytetrafluoroethylene, the inner liner comprising:
an inner surface disposable in contact with an outer surface of a sway bar;
an outer surface; and
a helical rib protruding radially outwardly from the outer surface of the inner liner and into the outer body from the inner surface thereof, the interface between the helical rib and the outer body strengthening engagement between the outer body and the inner liner.

2. The sway bar bushing of claim 1, wherein the helical rib of the inner liner completes at least one complete circumnavigation of the outer surface along the length of the inner liner.

3. The sway bar bushing of claim 1, wherein the outer body is fabricated from polyurethane.

4. The sway bar bushing of claim 1, wherein an axial slit is formed along the length of the sway bar bushing.

5. The sway bar bushing of claim 1, comprising a generally cylindrical shape.

6. The sway bar bushing of claim 1, wherein the outer wall of the outer body has an elevated midsection protruding outwardly from the surface of the outer wall, the elevated midsection being adapted to interface with a sway bar mounting bracket.

7. A sway bar bushing comprising:
an outer body having an outer wall surface and an inner wall surface, the outer wall surface being adapted to interface with a sway-bar mounting bracket; and
an inner liner comprising:
an inner surface disposable in contact with an outer surface of a sway bar;
an outer surface; and
a rib protruding radially outwardly from the outer surface of the inner liner and into the outer body from the inner surface thereof, the interface between the rib and the outer body strengthening engagement between the outer body and the inner liner.

8. The sway bar bushing of claim 7, wherein the inner liner is formed of polytetrafluoroethylene.

9. The sway bar bushing of claim 7, wherein the inner liner is formed around a core pin.

10. The sway bar bushing of claim 7, wherein the outer body is formed by casting polyurethane into a mold around the inner liner disposed upon the core pin.

11. The sway bar bushing of claim 7, wherein the rib of the inner liner is helical in form.

12. A sway bar bushing comprising:
a liner having an inner surface and an outer surface, the outer surface having an outwardly radially protruding rib, the inner surface being disposable in contact with an outer surface of a sway bar
an outer body comprising:
an outer wall being adapted to interface with a sway bar mounting bracket; and
an inner wall being formed to retain at least a portion of the helical rib, and further formed to at least partially integrate with the outer surface of the inner liner.

13. A method of forming a sway bar bushing, the method comprising the steps of:
forming an inner liner of polytetrafluoroethylene, the inner liner comprising:
an inner surface disposable in contact with an outer surface of a sway bar;
an outer surface; and
a helical rib protruding radially outwardly from the outer surface of the inner liner
forming an outer body around the inner liner, the outer body having an outer surface and an inner surface, the outer surface being adapted to interface with a sway-bar mounting bracket,
the outer body being formed on the inner liner such that the helical rib extends into the inner surface of the outer body, the interface between the helical rib and the outer body strengthening engagement between the outer body and the inner liner.

14. The method of claim 13, wherein the step of forming the outer body includes molding the outer body to the inner liner.

15. The method of claim 13 wherein the step of forming the outer body includes atmospheric casting of the outer body to the inner body.

16. The method of claim 13, further comprising the step of allowing the formed outer body to cure to the inner liner.

17. The method of claim 13, wherein the step of forming the outer body includes forming the outer body of polyurethane.

18. The method of claim 13, wherein the step of forming the outer body includes allowing the material that forms the outer body to become at least partially incorporated into the outer surface of the inner liner.

19. The method of claim 13, wherein the step of forming a sway bar bushing includes forming a generally cylindrical sway bar bushing, wherein the generally cylindrical sway bar bushing comprises a first end opening and a second end opening.

20. The method of claim 19, further comprising the step of cutting a slice through completed sway bar bushing, wherein the slice is cut from the first end opening to the second end opening.

21. The method of claim 13, wherein the step of forming an inner liner includes ultrasonically welding the inner liner, creating a helical rib.
